(19) United States
(12) Patent Application Publication
(10) Pub. No.: US 2004/0235570 A1
(43) Pub. Date: Nov. 25, 2004

(54) Gaming machine with personal climate Control

(76) Inventors: Wayne H. Rothschild, Northbrook, IL (US); Richard J. Vargas, Chicago, IL (US)

Correspondence Address: JENKENS & GILCHRIST, P.C., 225 WEST WASHINGTON, SUITE 2600, CHICAGO, IL, 60606, US

(21) Appl. No.: 10/444,733

(22) Filed: May 22, 2003

(51) Int. Cl. A63F 13/00

(52) U.S. Cl. 463/46

(57) ABSTRACT

A gaming machine is operable to create a preferred personal environment for a player playing a wagering game on the machine. The machine comprises at least one vent for emitting air into a vicinity of the machine, a delivery medium for conveying the air to the vent, and at least one climate control, operable by a player, for adjusting a characteristic of the air. The characteristic may, for example, be a velocity, temperature, direction or scent of the air.

### FIELD OF THE INVENTION

The present invention relates generally to gaming machines and, more particularly, to a gaming machine with climate control for creating a preferred personal environment for a player playing a wagering game on the machine.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator. Accordingly, in the competitive gaming machine industry, there is a continuing need for gaming machine manufacturers to produce new types of games, or enhancements to existing games that will attract frequent play by enhancing the entertainment value and excitement associated with the game.

Other aspects of increasing game play involve the ability to place games at “ideal” locations during “ideal” playing times and the ability to make the player as comfortable as possible to increase the length of time they spend at the gaming machine. Currently, gaming machines are typically placed in close proximity to each other creating a shared environment with the machines on either side. Players of these machines are subject to the environment of the gaming machines to either side and to environments created by the players on either side. This is especially true for those players who are non-smokers and have to endure a less than appealing environment if a smoker is playing the machine near or next to them. Furthermore, casinos typically place gaming machines in large rooms with the climate controlled by the operator. Individuals typically have different comfort zones for temperature and have no control over the casino's environment.

With the lack of control over their environment, players may not stay at a gaming machine if they become uncomfortable due to second hand smoke or an unsatisfactory air temperature.

### SUMMARY OF THE INVENTION

The present invention provides a gaming machine for creating a preferred personal environment for a player playing a wagering game on the machine. The machine comprises at least one vent for emitting air into a vicinity of the machine, a delivery medium for conveying the air to the vent, and at least one climate control, operable by a player, for adjusting a characteristic of the air. The characteristic may, for example, be a velocity, temperature, direction or scent of the air.

### BRIEF DESCRIPTION OF THE DRAWINGS

The foregoing and other advantages of the invention will become apparent upon reading the following detailed description and upon reference to the drawings in which:

FIG. 1 is a front view of a gaming machine with personal climate control in accordance with the present invention;

FIG. 2 is a block diagram of a control system suitable for operating the gaming machine;

FIGS. 3a and 3b are enlarged views of player-adjustable climate controls on a front panel of the gaming machine; and

FIG. 4 is a cutaway side view of the gaming machine depicting internal climate control and delivery mechanisms.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

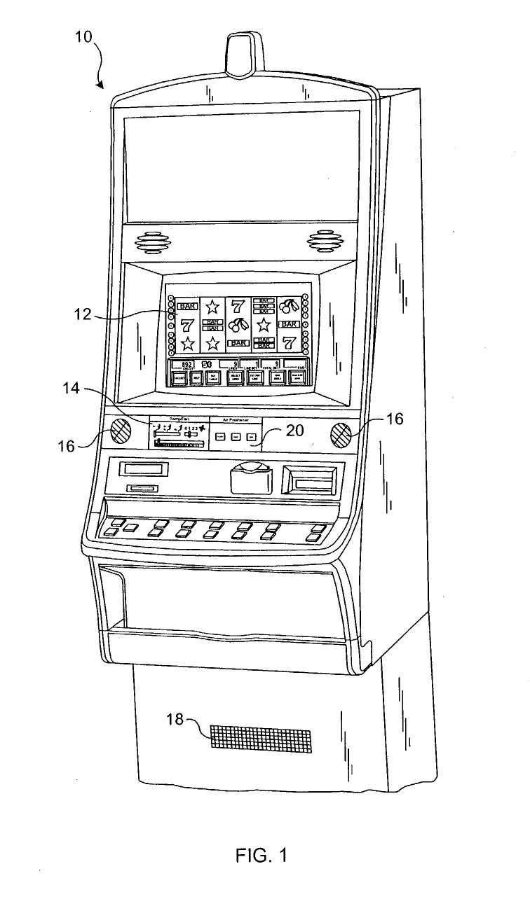

FIG. 1 depicts a gaming machine 10 operable to conduct a slot-based wagering game. In operation, the gaming machine receives a wager from a player to purchase a “play” of the game. In a “play” of the game, the gaming machine generates at least one random event using a random number generator (RNG) and provides an award to the player for a winning outcome of the random event. The random event may be generated locally at the gaming machine or remotely at a remote computer. If the random event is generated at a remote computer, the remote computer may use either an RNG or pooling schema for its central determination of a game outcome. To portray the random event and outcome to the player, the gaming machine includes a primary display 12. If the wagering game is a reel slot game, for example, the primary display 12 includes a plurality of symbol-bearing reels that are rotated and stopped to place symbols on the reels in visual association with the pay line.

The primary display 12 may be implemented with a CRT, LCD, plasma, mechanical reels (in the case of a reel slot game), or other type of display known in the art. The primary display 12, especially if implemented in video, may be overlaid with a touch screen to facilitate interaction with the player. In the illustrated embodiment, the gaming machine 10 is an “upright” version in which the primary display 12 is oriented vertically relative to the player. Alternatively, the gaming machine may be a “slant-top” version in which the primary display 12 is slanted at about a thirty-degree angle toward the player of the gaming machine 10.

The gaming machine in FIG. 1 includes an example of a climate control system operable by the player through controls 14, 20 displayed on the front panel. The climate control system may, for example, include a temperature control mechanism, a fan mechanism, and a scent mechanism, selectable by the player to produce a preferred personal environment at the gaming machine. The climate control system delivers air through direction-alterable vents 16 located below the display 12 and a fixed vent 18 located near the bottom of the gaming machine. The vents 16 allow the player to direct the air flow in different directions (e.g., upward, downward, to the right, to the left, etc.) in order to create a comfortable personal space around them. For example, if the player is a non-smoker and a smoker is playing the adjacent gaming machine, the non-smoker can switch on the fan using the controls 14 and position the air flow emitted from vents 16 to move the air in such a fashion as to keep the unwanted smoke from entering the non-smoker's playing area. Alternative locations for controls and vents may be deployed to support the mechanics of the gaming machine, the presentation of the interface, or the ease of use. For example, if the display 12 is a video display, the controls may be depicted on the video display and operated via an overlying touch screen.

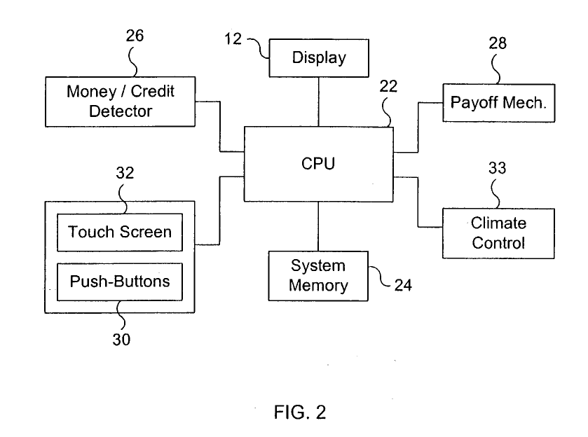

FIG. 2 is a block diagram of a control system suitable for operating the gaming machine. Money/credit detector 26 signals a central processing unit (CPU) 22 when a player has inserted money or played a number of credits. The money may be provided by coins, bills, tickets, coupons, electronic fund transfer, cards, etc. Using a button panel 30 the player may select any variables associated with the wagering game and place his/her wager to purchase a play of the game. In a play of the game, the CPU 22 (or remote computer) generates at least one random event using a random number generator (RNG) or pooling schema and provides an award to the player for a winning outcome of the random event. The CPU 22 operates the display 12 to represent the random event(s) and outcome(s) in a visual form that can be understood by the player. In addition to the CPU 22, the control system may include one or more additional slave control units for operating the display 12 and any secondary displays.

System memory 24 stores control software, operational instructions and data associated with the gaming machine. In one embodiment, the system memory 24 comprises a separate read-only memory (ROM) and battery-backed random-access memory (RAM). However, it will be appreciated that the system memory 24 may be implemented on any of several alternative types of memory structures or may be implemented on a single memory structure. A payoff mechanism 28 is operable in response to instructions from the CPU 22 to award a payoff to the player. The payoff may, for example, be in the form of a number of credits. The number of credits is determined by one or more math tables stored in the system memory 24.

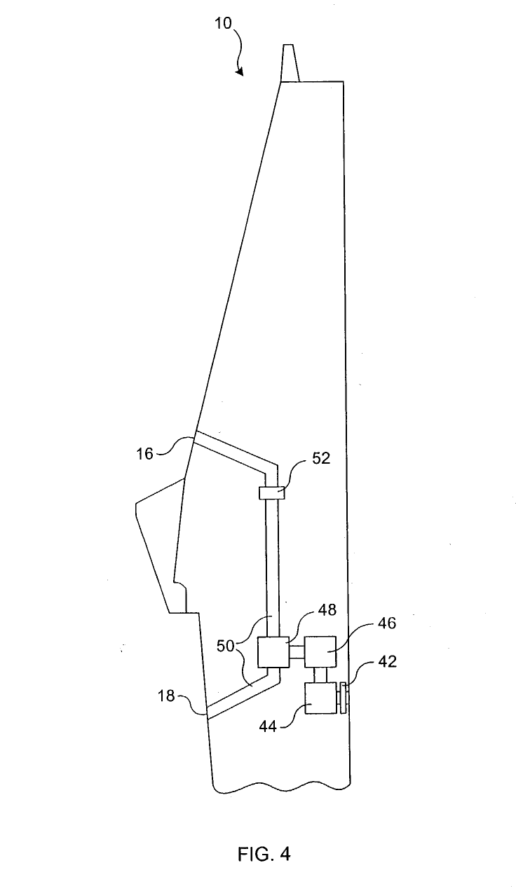

Additionally, a climate controller 33 may be implemented to facilitate the player-alterable climate controls 14, 20 on the front of the gaming machine 10 and the internal system defined in FIG. 4. Alternatively, the climate control system may be implemented as a separate, stand-alone mechanism from the CPU 22-based control system.

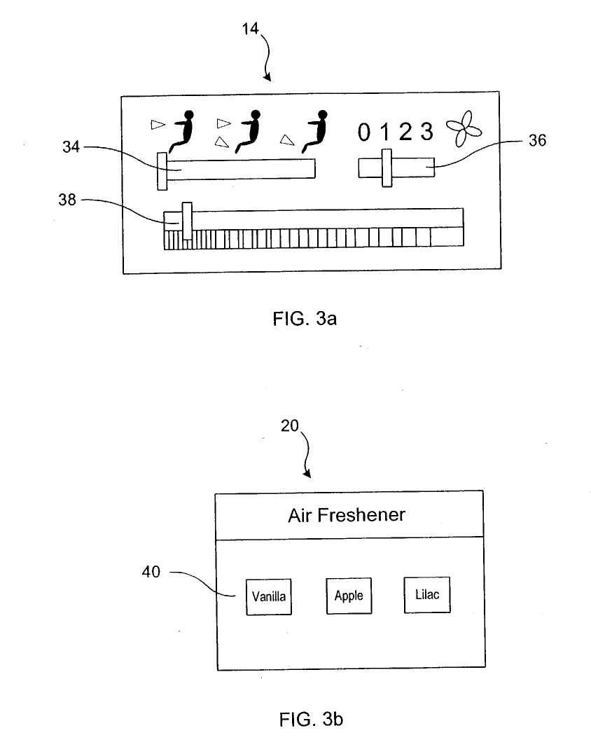

FIGS. 3a and 3b are enlarged views of the player-adjustable climate controls displayed on the front panel of the gaming machine. Referring to FIG. 3a, a temperature/fan control 14 contains a directional control 34 to direct the flow of air to the players upper body area through player-adjustable vents 16, to the players lower body area (feet, legs) through vent 18, or to both. The speed of the air flow is determined by a fan control 36. The fan control 36 operates with a plurality of fan speeds and may include an “off” selection. A selector knob or switch that comprises the fan control 36 can be adjusted by the player to the desired setting based on the player's preference for the amount of air flow emitted from the vents 16, 18. Typically, the selector is numbered with the lowest number represent the slowest fan speed or off (equaling minimal air flow or no air flow), and the highest number representing the highest fan speed (equaling maximum air flow). Variants of this type of visual display may also be used such as a step graphic with the lowest point of the steps representing the slowest fan speed and air flow to the highest steps representing the highest fan speed and air flow. A temperature control 38 is also present allowing the player to select from a range of temperatures based on a visual gauge. A visual gauge on the temperature control 38 may be numeric with the lowest number equaling the coolest temperature and the highest number equaling the warmest temperature of the air emitted from the vents 16, 18. The visual gauge of the temperature control 38 may also be a color coded bar display with the left half of the bar colored blue to represent cold and the right half of the bar colored red to represent warm or hot. A graduated change from one side of the bar to the other represents a mixture of cold and warm air. All switches and controls may be oriented in a fashion that supports the mechanics of the gaming machine, the presentation of the interface, or ease of use.

Referring to FIG. 3b, a scent delivery control 20 allows the player to select from a plurality of olfactory-affecting scents or aromas. A selection of buttons 40 with the scents defined is presented that, when pushed, releases a mist containing the scent into the air flow of the climate control system. Selection of scents may also be performed from a touch screen interface. The selectable scents may, for example, include vanilla, apple, and lilac. Additional or fewer scents and corresponding buttons may be provided. Scents may be theme specific and “downloadable” from a central server or the Internet.

FIG. 4 shows a cutaway view of the gaming machine 10 and presents an example of the internal mechanisms for delivering the climate control to the player. A blower/fan assembly 44 pulls air from outside the gaming machine 10, through an optional air filter 42, and pushes it through a vent pipe to a heating/cooling mechanism 46. The heating/cooling mechanism 46 may derive its temperature altering capability from a variety of sources including heat generated from the machine's power supply device, cooling from an outside source such as an air conditioning system, and/or other sources that efficiently support the delivery of the player's preferred personal environment. Once the air has passed through the heating/cooling mechanism 46, it passes through a flow director/baffle 48 moving the air to the correct vent pipes 50 as selected by the player using the directional control 34 on the temperature/fan control panel 14 (see FIG. 3a). If the air passes through the upper vent piping, it may also be affected by a scent delivery mechanism 52. The scent delivery mechanism 52 contains a plurality of scents initiated by the player through the scent delivery control 20 (see FIG. 3b). The introduction of these scents into the air flow may be accomplished through a variety of methods including replaceable spray devices, solid air fresheners, or other olfactory devices. Once through the scent delivery mechanism 52, the air passes through the player-adjustable vent 16. The scent delivery mechanism 52 may be selectively activated by the player via the scent delivery control 20 (see FIG. 3b) or, alternatively, activated by a remote server. Commercially available technology for the delivery of scent simulations is available from companies such as TriSenx Holdings, Inc. of Savannah, Ga., and The Effects Company of England, U.K. Alternatively, the scent delivery mechanism 52 may be a separate device. Air traveling through the lower vent pipe exits the gaming machine through vent 18.

While the present invention has been described with reference to one or more particular embodiments, those skilled in the art will recognize that many changes may be made thereto without departing from the spirit and scope of the present invention.

For example, in place of the temperature control 38, an automatic thermostat with a numeric digital display and controls allowing the player to set a specific temperature may be deployed. Additional player-controlled climate features such as a humidifier, fresh air delivery, and/or oxygen-enriched air may also be included in the climate control system.

Each of these embodiments and obvious variations thereof is contemplated as falling within the spirit and scope of the claimed invention, which is set forth in the following claims.

What is claimed is:

1. A gaming machine for creating a preferred personal environment in a vicinity thereof, the machine comprising:
at least one vent for emitting air into said vicinity;
a delivery medium for conveying said air to said vent; and
at least one climate control, operable by a player, for adjusting a characteristic of said air.

2. The machine of claim 1, further including a heating/cooling mechanism coupled to said delivery medium, said characteristic being a temperature of said air.

3. The machine of claim 1, further including a scent delivery mechanism coupled to said delivery medium, said characteristic being a scent of said air.

4. The machine of claim 3, wherein said scent delivery mechanism includes sources for a variety of different aromas, and wherein said at least one climate control is operable by said player to select one of said different aromas.

5. The machine of claim 1, further including a blower mechanism coupled to said delivery medium, said characteristic being a velocity of said air.

6. The machine of claim 1, wherein said at least one vent includes a plurality of vents, and further including a flow director coupled to said delivery medium for directing said air to selected ones of said vents.

7. The machine of claim 6, wherein said plurality of vents include a first vent facing said player's upper body and a second vent facing said player's lower body as said player is positioned to play a wagering game on the gaming machine.

8. The machine of claim 1, wherein said delivery medium includes a pipe.

9. The machine of claim 1, wherein said vent is adjustable to alter a direction of said air emitted therefrom.

10. The machine of claim 1, further including a processor for conducting a wagering game.

11. The machine of claim 1, wherein said characteristic is selected from a group consisting of velocity, temperature, direction and scent.

12. A climate control system for a gaming machine for creating a preferred personal environment in a vicinity of the gaming machine, the system comprising:
at least one vent for emitting air into said vicinity;
a delivery medium for conveying said air to said vent; and
at least one climate control, operable by a player, for adjusting a characteristic of said air.

13. The system of claim 12, further including a heating/cooling mechanism coupled to said delivery medium, said characteristic being a temperature of said air.

14. The system of claim 12, further including a scent delivery mechanism coupled to said delivery medium, said characteristic being a scent of said air.

15. The system of claim 14, wherein said scent delivery mechanism includes sources for a variety of different aromas, and wherein said at least one climate control is operable by said player to select one of said different aromas.

16. The system of claim 12, further including a blower mechanism coupled to said delivery medium, said characteristic being a velocity of said air.

17. The system of claim 12, wherein said at least one vent includes a plurality of vents, and further including a flow director coupled to said delivery medium for directing said air to selected ones of said vents.

18. The system of claim 17, wherein said plurality of vents include a first vent facing said player's upper body and a second vent facing said player's lower body as said player is positioned to play a wagering game on the gaming machine.

19. The system of claim 12, wherein said delivery medium includes a pipe.

20. The system of claim 12, wherein said vent is adjustable to alter a direction of said air emitted therefrom.

21. The system of claim 12, further including a processor for conducting a wagering game.

22. The system of claim 12, wherein said characteristic is selected from a group consisting of velocity, temperature, direction and scent.

23. A gaming machine for creating a preferred personal environment in a vicinity thereof, the machine comprising:
means for emitting air into said vicinity;
means for conveying said air to said vent; and
means, operable by a player, for adjusting a characteristic of said air.

24. A method of creating a preferred personal environment in a vicinity of a gaming machine, the method comprising:
conveying air to at least one vent on the gaming machine via a delivery medium;
emitting said air from said vent into said vicinity; and
adjusting, in response to player operation of a climate control on the gaming machine, a characteristic of said air.

25. The method of claim 24, further including a heating/cooling mechanism coupled to said delivery medium, said characteristic being a temperature of said air.

26. The method of claim 24, further including a scent delivery mechanism coupled to said delivery medium, said characteristic being a scent of said air.

27. The method of claim 26, wherein said scent delivery mechanism includes sources for a variety of different aromas, and wherein said adjusting step includes selecting one of said different aromas.

28. The method of claim 24, further including a blower mechanism coupled to said delivery medium, said characteristic being a velocity of said air.

29. The method of claim 24, wherein said at least one vent includes a plurality of vents, further including a flow director coupled to said delivery medium, and further including directing said air to at least one of said vents selected by a player.

30. The method of claim 29, wherein said plurality of vents include a first vent facing said player's upper body and a second vent facing said player's lower body as said player is positioned to play a wagering game on the gaming machine.

31. The method of claim 24, wherein said delivery medium includes a pipe.

32. The method of claim 24, wherein said vent is adjustable to alter a direction of said air emitted therefrom.

33. The method of claim 24, wherein said characteristic is selected from a group consisting of velocity, temperature, direction and scent.

34. A method of operating a gaming machine, the method comprising:
conveying air to at least one vent on the gaming machine via a delivery medium;
emitting said air from said vent into a vicinity of the gaming machine;
adjusting, in response to player operation of a climate control on the gaming machine, a characteristic of said air; and
conducting a wagering game on the gaming machine.

35. A method of creating a preferred personal environment in a vicinity of a gaming machine, the method comprising:
blowing air from the gaming machine into said vicinity; and
adjusting, in response to player operation of a climate control on the gaming machine, a velocity of said blown air.

36. The method of claim 35, wherein said blowing step is performed with a fan on the gaming machine, and wherein said climate control includes a fan control.

37. The method of claim 36, further including conveying said air to a vent via a delivery medium, said fan being coupled to said delivery medium for blowing said air through said vent.

38. The method of claim 37, further including adjusting said vent to alter a direction of said air emitted therefrom.

39. A gaming machine for creating a preferred personal environment in a vicinity thereof, the machine comprising:
a fan for blowing air into said vicinity; and
at least one fan control, operable by a player, for adjusting a velocity of said blown air.

40. The machine of claim 39, further including a vent and a delivery medium for conveying said air to said vent, said fan being coupled to said delivery medium for blowing said air through said vent.

41. The machine of claim 40, wherein said vent is adjustable to alter a direction of said air emitted therefrom.
